(19) United States
(12) Patent Application Publication
(10) Pub. No.: US 2024/0363935 A1
(43) Pub. Date: Oct. 31, 2024

(54) DEVICE FOR FORMING SHARK FIN OF 3-SIDED SEALING POUCH TYPE SECONDARY BATTERY

(71) Applicant: CLEVER CO., LTD., Chungcheongbuk-do (KR)

(72) Inventors: Jong Hong JEONG, Chungcheongbuk-do (KR); Sang Jin KIM, Daejeon Metropolitan City (KR)

(21) Appl. No.: 18/682,582

(22) PCT Filed: Aug. 10, 2022
(86) PCT No.: PCT/KR2022/011901

§ 371 Date: Feb. 9, 2024

(30) Foreign Application Priority Data
Aug. 13, 2021 (KR) 10-2021-0107635

(51) Int. Cl. H01M 50/184; H01M 50/105

(52) U.S. Cl. CPC H01M 50/184; H01M 50/105

(57) ABSTRACT

The disclosed device for forming a shark fin of a 3-sided sealing pouch type secondary battery includes: lower molds on which lower surfaces of shark fins formed outside front and rear ends of a sealed surface and an accommodation part of a 3-sided sealing pouch type secondary battery, and a lower surface of a terrace connected to the shark fins are seated; and upper molds pressing the shark fins seated on the lower molds, and the terrace connected to the shark fins to form folding lines between the shark fins and the terrace.

### TECHNICAL FIELD

The present invention relates to a device for forming a shark fin of a 3-sided sealing pouch type secondary battery, and particularly, to a device for forming a shark fin of a 3-sided sealing pouch type secondary battery which can form a folding line which is a folding reference line in a shark fin to fold the 3-sided sealing pouch type secondary battery.

### BACKGROUND ART

This section provides background information related to the present invention which is not necessarily prior art.

Secondary batteries are widely used as a power source for mobile devices such as mobile phones and laptops. In particular, the use of lithium secondary batteries is rapidly increasing due to the advantages of high operating voltage and high energy density per unit weight.

These lithium secondary batteries mainly use lithium-based oxide as a positive electrode active material and carbon material as a negative electrode active material, and depending on the type of electrolyte, the lithium secondary batteries may be classified into lithium-ion batteries, lithium-ion polymer batteries, and lithium polymer batteries, and depending on an outer shape of the battery, the lithium secondary batteries may be classified into cylindrical, prismatic, and pouch type secondary batteries.

Representatively, in terms of battery shape, there is high demand for the prismatic secondary batteries and the pouch type secondary batteries that can be applied to products due to a thin thickness thereof.

In particular, an interest in the pouch type secondary batteries is concentrated because pouch type secondary batteries have no restrictions on shape and size, are easy to assemble through heat fusion, and easily effectively expel gas or liquid when abnormal behavior occurs, making them suitable for manufacturing lightweight and thin thickness cells.

Generally, the pouch type secondary battery has a structure in which an electrode assembly is built into a pouch exterior material made of an aluminum laminate sheet. That is, the pouch type secondary battery forms an accommodating part for mounting the electrode assembly on the aluminum laminate sheet, and with the electrode assembly mounted on the accommodating part, a separate aluminum laminate sheet or an extended aluminum laminate sheet is separated from the aluminum laminate sheet is thermally fused and manufactured.

Meanwhile, in the detachable pouch exterior material, two aluminum laminate sheets are combined by overlapping and sealing each other, so during the manufacturing process of the secondary battery, the accommodation parts on both sides must be overlapped in the correct position with the electrode assembly built in. In addition, since two units of aluminum laminate sheets are joined on four sides to form a sealing portion, all four sealed surfaces come into contact with the atmosphere, which greatly increases the possibility of air entering during long-term use, thereby shortening the lifespan of the battery.

To solve this problem, techniques have been introduced for forming two corresponding accommodation parts on one aluminum laminate sheet, overlapping them, and sealing the three sides.

FIG. 1 is a diagram illustrating a 3-sided sealing pouch type secondary battery related to the present invention, and the 3-sided sealing pouch type secondary battery 10 is manufactured by forming two accommodation parts 14 having shapes and sizes perfectly corresponding on one pouch laminate sheet 12, bending a central portion between accommodation parts 14, and overlapping the accommodation parts 14 under a state in which an electrode assembly (not illustrated) is mounted on any one accommodation part 14, and sealing three remaining 3 sides other than the bent side.

The 3-sided sealing pouch type secondary battery 10 may reduce the depth of the accommodation part 14 formed on the pouch laminate sheet 12 to approximately half the thickness of the electrode assembly and may maintain a state in which one side 16 (hereinafter, referred to as ‘sealed surface’) among four sides is sealed.

However, in the above-mentioned 3-sided sealing pouch type secondary battery 10, there is a problem in that while the pouch laminate sheet 12 of the sealed surface 16 on 3 sides is pressed during sealing on 3 sides, burr-shaped shark fins 18 are formed between both ends of the sealed surface 16 and a terrace 20 illustrated in FIG. 1.

In the 3-sided sealing pouch type secondary battery 10 manufactured by the shark fin 18 formed in this way, there is another problem in that a design error occurs, and as a result, assembly is not easy when the 3-sided sealing pouch type secondary battery 10 is assembled to a battery module, etc.

### DISCLOSURE

### Technical Problem

One object of the present invention is to provide a device for forming a shark fin of a 3-sided sealing pouch type secondary battery which may form a folding line which is a folding reference line in a shark fin to fold the 3-sided sealing pouch type secondary battery.

One object of the present invention is to provide a device for forming a shark fin of a 3-sided sealing pouch type secondary battery which may form the folding line while ensuring electrical insulation for an adhesive layer.

Further, an object to be achieved by the present invention is not limited to the aforementioned technical objects, and other technical objects, which are not mentioned above, will be apparently appreciated by a person having ordinary skill in the art from the following description.

### Technical Solution

This section provides a general summary of the invention and is not a comprehensive invention of its full scope or all of its features.

In order to solve the problem, a device for forming a shark fin of a 3-sided sealing pouch type secondary battery according to any one aspect of various aspects for describing the present invention includes: lower molds on which the shark fins formed outside front and rear ends of a sealed surface and an accommodation part of a 3-sided sealing pouch type secondary battery, and a lower surface of a terrace connected to the shark fins are seated; and upper molds pressing the shark fins seated on the lower molds, and the terrace connected to the shark fins to form folding lines between the shark fins and the terrace, and the folding lines may be formed to be aligned with the sealed surface up to a location adjacent to the sealed surface and the accommodation part from both ends of the terrace facing the sealed surface, and the folding lines may be formed to have a length corresponding to a sealing area of the terrace, and the folding lines may be formed to maintain an interval of 1 mm or more from the accommodation part.

In the device for forming a shark fin of a 3-sided sealing pouch type secondary battery according to one aspect of the present invention, forming processing surfaces on which the shark fins formed outside the front and rear ends of the sealed surface and the accommodation part, and the lower surface of the terrace connected to the shark fins are seated may be formed on upper surfaces of the lower molds.

In the device for forming a shark fin of a 3-sided sealing pouch type secondary battery according to one aspect of the present invention, a concave folding line forming groove may be formed on the forming processing surface in a longitudinal direction of the sealed surface.

In the device for forming a shark fin of a 3-sided sealing pouch type secondary battery according to one aspect of the present invention, heating elements may be installed inside the lower molds.

In the device for forming a shark fin of a 3-sided sealing pouch type secondary battery according to one aspect of the present invention, the lower molds may be guided to a folding line forming location jointly with the upper molds by actuation of an X-axis transfer means to seat the shark fins, and a lower surface of the terrace connected to the shark fins on the forming processing surface, and be returned by the actuation of the X-axis transfer means jointly with the upper molds upon completing the forming of the folding line.

In the device for forming a shark fin of a 3-sided sealing pouch type secondary battery according to one aspect of the present invention, a convex folding line forming protrusion which is extended in the longitudinal direction of the sealed surface, and matched with the folding line forming groove to form the folding line may be formed on lower surfaces of the upper molds.

In the device for forming a shark fin of a 3-sided sealing pouch type secondary battery according to one aspect of the present invention, a cross-sectional shape of one end or both ends of the folding line forming protrusion may be formed to be gradually reduced to a side surface of the upper mold.

In the device for forming a shark fin of a 3-sided sealing pouch type secondary battery according to one aspect of the present invention, a pressing area pressing the shark fins and both terraces flatly may be formed on an outer side of extension ends of the folding line forming protrusion and the folding line forming groove forming an extension end of the folding line at a location adjacent to the front and rear ends of the sealed surface and the accommodation part.

In the device for forming a shark fin of a 3-sided sealing pouch type secondary battery according to one aspect of the present invention, heating elements may be installed inside the upper molds.

In the device for forming a shark fin of a 3-sided sealing pouch type secondary battery according to one aspect of the present invention, the upper molds may be guided to a folding line forming location jointly with the lower molds by actuation of an X-axis transfer means, and moved down by actuation of a Z-axis transfer means, and press spaces between the shark fins seated on the forming processing surface and the terrace to bend and form the folding lines between the shark fins and the terrace, and moved up by the actuation of the Z-axis transfer means upon completing the forming of the folding line, and at the same time, returned by the actuation of the X-axis transfer means jointly with the lower molds.

### Advantageous Effects

According to the present invention, an effect can be provided, in which a folding line which is a folding reference line can be easily formed in shark fins of the 3-sided sealing pouch type secondary battery, and as a result, the shark fin can be easily folded in a subsequent process.

According to the present invention, since heat and pressure are assigned upon forming the folding line, a melted adhesive layer can flow to a portion where electrical insulation is broken due to the forming of the folding line, and as a result, an effect can be provided, which can ensure the electrical insulation for the adhesive layer.

### DESCRIPTION OF DRAWINGS

FIG. 1 is a plan view of a 3-sided sealing pouch type secondary battery related to the present invention.

FIG. 2 is a process diagram schematically illustrating a process in which shark fins of the 3-sided sealing pouch type secondary battery related to the present invention are folded.

FIG. 3 is a diagram illustrating the shark fin forming device of the 3-sided sealing pouch type secondary battery according to the present invention illustrated in FIG. 2.

FIG. 4 is a front view enlarging and illustrating an upper mold and a lower mold illustrated in FIG. 3.

FIG. 5 is a side view of the upper mold and the lower mold illustrated in FIG. 4.

FIG. 6 is a diagram illustrating a folding line formed to the shark fins of the 3-sided sealing pouch type secondary battery by the shark fin forming device of the 3-sided sealing pouch type secondary battery according to the present invention.

### MODES OF THE INVENTION

Hereinafter, an exemplary embodiment of implementing a 3-sided sealing pouch type secondary battery according to the present invention will be described in detail with reference to drawings.

However, it cannot be said that the intrinsic technical spirit of the invention is limited to an exemplary embodiment described below, and it is disclosed that the technical spirit includes a scope which may be easily proposed by a method of substitutions or changes for the exemplary embodiment described below based on the intrinsic technical spirit of the invention by those skilled in the art.

Further, since terms used below are selected for easy description, the terms are not limited to dictionary meanings and should be appropriately interpreted as meanings consistent with the technical spirit of the invention in order to grasp the intrinsic technical spirit of the invention.

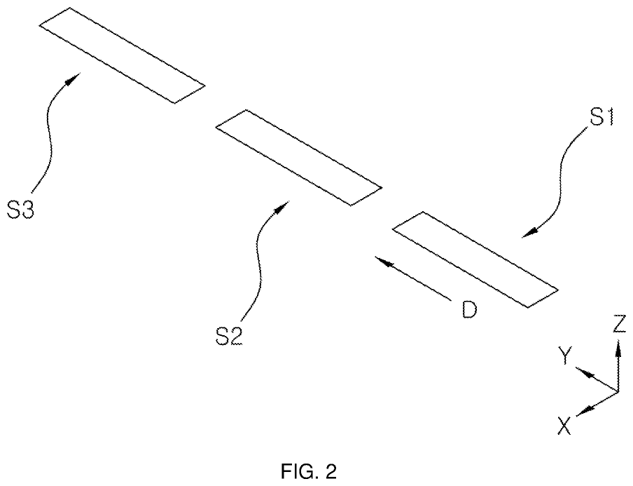

Among the accompanying drawings, FIG. 2 is a process diagram schematically illustrating a process in which shark fins of the 3-sided sealing pouch type secondary battery related to the present invention are folded.

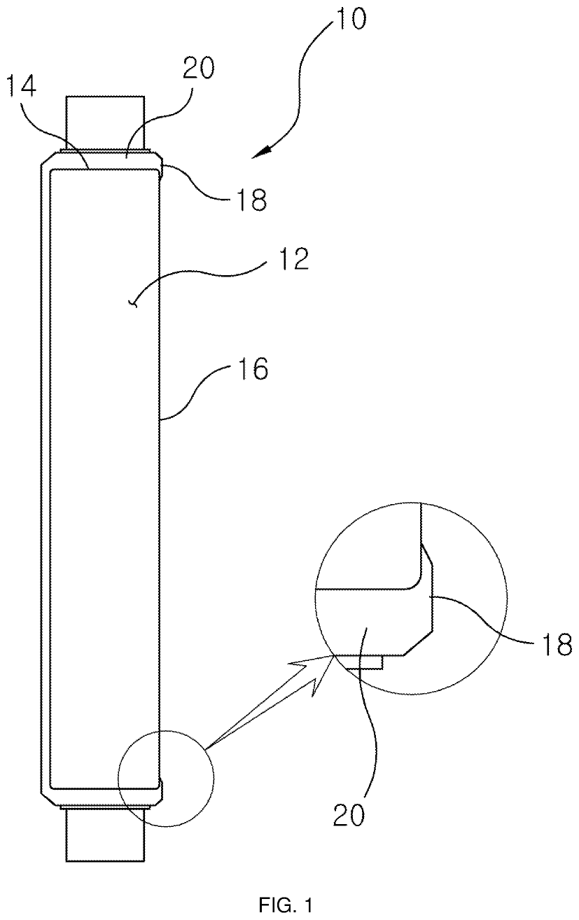

Referring to FIG. 2, both ends of a sealed surface 16 of the 3-sided sealing pouch type secondary battery 10 (see FIG. 1) related to the present invention, and shark fins 18 formed in both terraces 20 connected to both ends of the sealed surface 16 are folded in a predetermined shape while sequentially going through a folding line forming process S1, a folding process S2, and a heating press process S3.

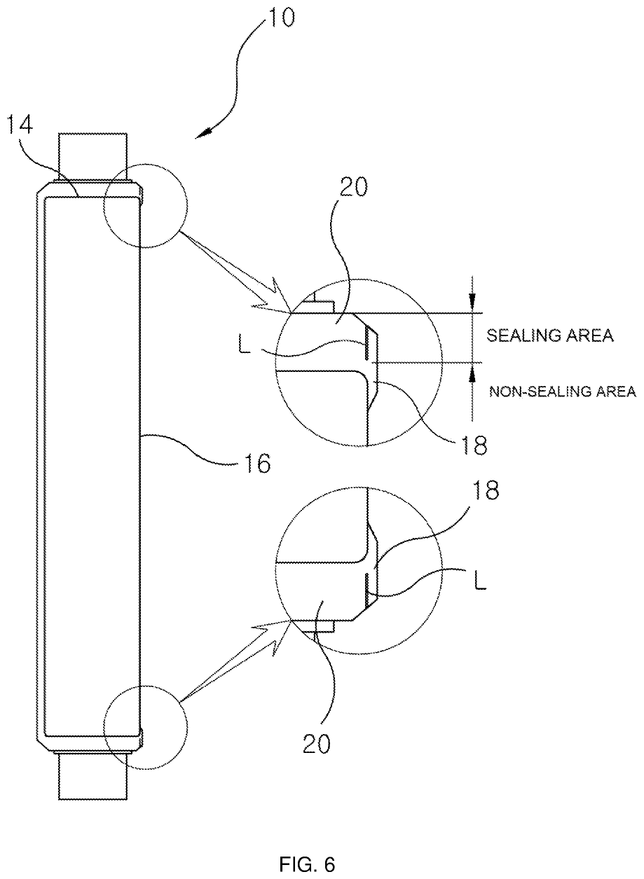

The folding line forming process S1 is a process of forming folding lines L (see FIG. 6) which are folding reference lines between the terraces 20 and the shark fins 18 formed at both ends of the sealed surface 16, the folding process S2 is a process of folding the shark fin 18 upwards based on the folding line L, and the heating press process S3 is a process of completing shapes of the folded shark fins 18 so that the folded shark fins 18 are not restored to an original shape.

Preferably, the shark fins 18 are folded at 270° or more to be horizontal to the sealed surface 16.

More preferably, after the heating press process S3, a cooling process of cooling the shark fin 18 heated in the heating press process S3 may be further included.

Meanwhile, devices that perform the folding line forming process S1, the folding process S2, and the heating press process S3 are installed in line at one side of a process progress path D as illustrated.

In addition, for folding the shark fins 18, the 3-sided sealing pouch type secondary battery 10 is vacuum-adsorbed on a cell transfer shuttle (not illustrated) while the sealed surface 16 is laid down to face one side of the process progress path D, and the 3-sided sealing pouch type secondary battery 10 mounted on the cell transfer shuttle sequentially goes through the folding line forming process S1, the folding process S2, and the heating press process S3 by actuation of the cell transfer shuttle.

Here, the process progress path D which is formed in a Y-axis direction (see FIG. 2) as illustrated, means a path in which the 3-sided sealing pouch type secondary battery 10 is mounted on the cell transfer shuttle, and transferred for folding the shark fins 18.

The shark fin forming device 100 of the 3-sided sealing pouch type secondary battery according to the present invention is a device that performs the folding line forming process S1 among the above-described processes.

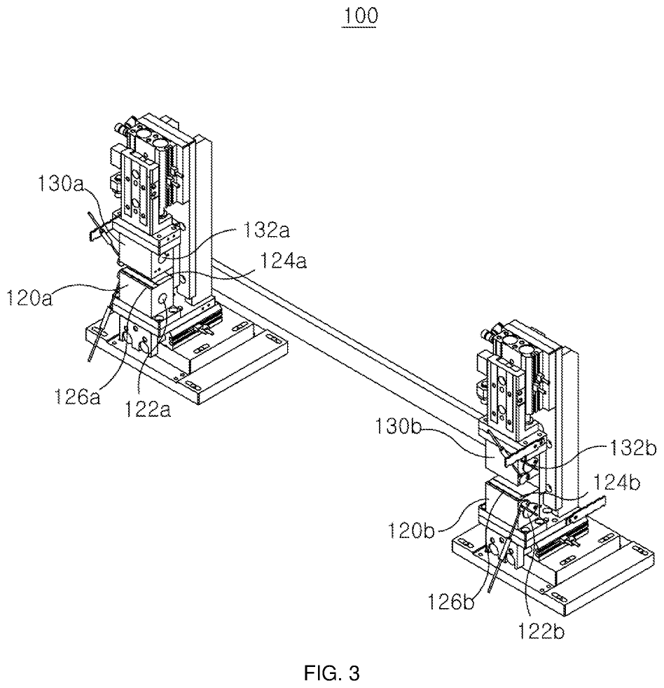

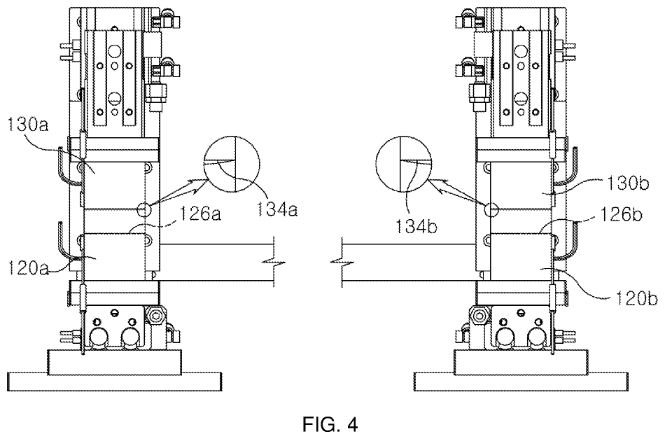

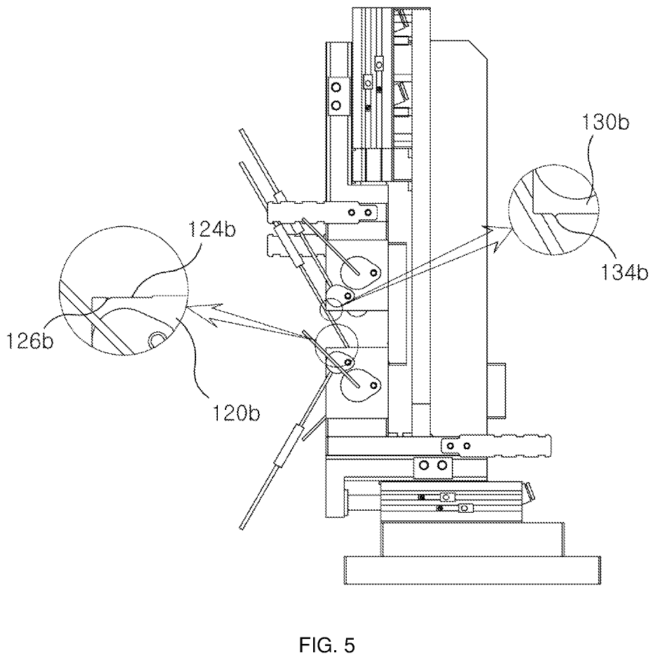

Among the accompanying drawings, FIGS. 3 to 5 are diagrams illustrating the shark fin forming device of the 3-sided sealing pouch type secondary battery according to the present invention.

Referring to FIGS. 3 to 5, the shark fin forming device 100 of the 3-sided sealing pouch type secondary battery according to the present invention includes lower molds 120a and 120b and upper molds 130a and 130b.

First, lower surfaces of shark fins 18 formed outside front and rear ends of the sealed surface 16 and the accommodation part 14 (main room), and a lower surface of the terrace 20 connected to the shark fins 18 are seated on the lower molds 120a and 120b.

The lower molds 120a and 210b are provided as a pair to face the shark fins 18 formed on the front and rear ends of the sealed surface 16 and the accommodation part 14 (main room) of the 3-sided sealing pouch type secondary battery 10, respectively.

The lower molds 120a and 210b are provided in an approximately hexahedral shape as illustrated and forming processing surfaces 124a and 124b on which the shark fin 18 and the terrace 20 formed outside the front and rear ends of the sealed surface 16 and the accommodation part 14 (main room) of the 3-sided sealing pouch type secondary battery 10 are formed on the upper surfaces of the lower molds 120a and 120b.

In this case, the forming processing surfaces 124a and 124b are formed to be precipitated on the upper surfaces of the lower molds 120a and 120b to be connected to the front surfaces of the lower molds 120a and 120b facing the process progress path D as illustrated, and concave folding line forming grooves 126a and 126b extended in a longitudinal direction of the sealed surface 16, i.e., a Y-axis direction are formed on the forming processing surfaces 124a and 124b.

The lower molds 120a and 120b are guided to a folding line forming location in an X-axis direction jointly with the upper molds 130a and 130b by actuation of a normal X-axis transfer means upon forming the folding line L, and in this case, the lower surfaces of the shark fins 18 formed outside the front and rear ends of the sealed surface 16 and the accommodation part 14 (main room) of the 3-sided sealing pouch type secondary battery 10, and the lower surface of the terrace 20 connected to the shark fins 18 are seated on the forming processing surfaces 124a and 124b. In addition, the lower molds 120a and 120b are returned in the X-axis direction by the actuation of the X-axis transfer means described above jointly with the upper molds 130a and 130b upon completing the forming of the folding line L.

In the accompanying drawing, a normal pneumatic cylinder is illustrated as the X-axis transfer means, but anyone will be able to see that the X-axis transfer means is not limited to the pneumatic cylinder.

The upper molds 130a and 130b press the shark fins 18 seated on the lower molds 120a and 120b, and the terrace 20 connected to the shark fins 18 to bend and form the folding lines L between the shark fins 18 and the terrace 20.

The upper molds 130a and 130b are provided as a pair to face the shark fins 18 formed on the front and rear ends of the sealed surface 16 and the accommodation part 14 of the 3-sided sealing pouch type secondary battery 10, respectively similarly to the lower molds 120a and 120b.

The upper molds 130a and 130b are provided in the approximately hexahedral shape as illustrated, and folding line forming protrusions 134a and 134b are formed on the lower surfaces of the upper molds 130a and 130b.

The folding line forming protrusions 134a and 134b are extended in the Y-axis direction as illustrated and matched with the folding line forming grooves 126a and 126b of the lower molds 120a and 120b.

In this case, a cross-sectional shape of one end or both ends of the folding line forming protrusions 134a and 134b is formed to be gradually reduced to side surfaces of the upper molds 130a and 130b. This is to bend an extension end of the folding line L adjacent to the front end and the rear end of the sealed surface 16 and the accommodation part 14 at a gentle curvature upon forming the folding line L.

Preferably, a pressing area (not illustrated) for preventing damage to folding lines L pressing the shark fins 18 and both terraces 20 flatly may be formed on an outer side of extension ends of the folding line forming protrusions 134a and 134b and the folding line forming grooves 126a and 126b forming an extension end of the folding line L at locations adjacent to the front and rear ends of the sealed surface 16 and the accommodation part 14 (main room).

The upper molds 130a and 130b are guided to folding line forming locations in the X-axis direction jointly with the lower molds 120a and 120b by the actuation of the X-axis transfer means described above upon forming the folding line L, and the upper molds 130a and 130b are moved down in a Z-axis direction by actuation of a normal Z-axis transfer means, and press spaces between the shark fins 18 seated on the forming processing surfaces 124a and 124b of the lower molds 120a and 120b, and the terrace 20 connected to the shark fins 18 to spread the shark fins 18 and the terrace 20 evenly and flatly, and at the same time, bend and form the folding lines L between the shark fins 18 and the terrace 20.

That is, the folding line forming protrusions 134a and 134b of the upper molds 130a and 130b guide and press the spaces between the shark fins 18 seated on the forming processing surfaces 124a and 124b of the lower molds 120a and 120b, and the terrace 20 to the insides of the folding line forming grooves 126a and 126b to bend and form the folding line L.

In addition, the upper molds 130a and 130b are moved up in the Z-axis direction by the actuation of the Z-axis transfer means described above upon completing the forming of the folding line L, and at the same time, returned in the X-axis direction jointly with the lower molds 120a and 120b by the actuation of the X-axis transfer means described above.

In the accompanying drawing, the normal pneumatic cylinder is illustrated as the Z-axis transfer means, but anyone will be able to see that the Z-axis transfer means is not limited to the pneumatic cylinder.

In the meantime, normal heating elements 122a and 122b heating the lower molds 120a and 120b to be maintained at a temperature of approximately 200° C. upon forming the folding line L are installed inside the lower molds 120a and 120b, and similarly, normal heating elements 132a and 132b heating the upper molds 130a and 130b to be maintained at the temperature of approximately 200° C. upon forming the folding line L are installed inside the upper molds 130a and 130b.

The lower molds 120a and 120b, and the upper molds 130a and 130b heated by the heating elements 122a, 122b, 132a, and 132b transfer heat to the adhesive layer of the shark fins 18 and the terraces 20 to melt the adhesive layer upon forming the folding line L, and the melted adhesive layer flows to a part where electrical insulation is broken while being pressed by the lower molds 120a and 120b, and the upper molds 130a and 130b, thereby restoring an insulating layer where the electrical insulation is broken.

The following briefly describes an operating state of the shark fin forming device 100 of the 3-sided sealing pouch type secondary battery according to the present invention formed as described above.

In a preceding process, when the 3-sided sealing pouch type secondary battery 10 is mounted on the cell transfer shuttle, and guided to the folding line forming location, the heating elements 122a, 122b, 132a, and 132b are first actuated to heat the lower molds 120a and 120b, and the upper molds 130a and 130b.

In addition, the X-axis transfer means is actuated to move the lower molds 120a and 120b, and the upper molds 130a and 130b to the folding line forming location.

In this case, lower surfaces of shark fins 18 formed outside front and rear ends of the sealed surface 16 and the accommodation part 14 (main room) of the 3-sided sealing pouch type secondary battery 10, and a lower surface of the terrace 20 connected to the shark fins 18 are seated on the forming processing surfaces 124a and 124b of the lower molds 120a and 120b.

When the lower surfaces of the shark fins 18 and the lower surface of the terrace 20 connected to the shark fins 18 are seated on the forming processing surfaces 124a and 124b of the lower molds 120a and 120b as described above, the Z-axis transfer means is actuated to move down the upper molds 130a and 130b to the forming processing surfaces 124a and 124b of the lower molds 120a and 120b.

In this case, the upper molds 130a and 130b press the shark fins 18 and the terrace 20 seated on the forming processing surfaces 124a and 124b of the lower molds 120a and 120b to spread the shark fins 18 and the terrace 20 evenly and flatly, and at the same time, the folding line forming protrusions 134a and 134b of the upper molds 130a and 130b guide and press the spaces between the shark fins 18 and the terrace 20 to the insides of the folding line forming grooves 126a and 126b to bend and form the folding lines L.

In this case, when the 3-sided sealing pouch type secondary battery 10 is viewed from the top as illustrated in FIG. 6, the folding lines L are formed to be aligned with the sealed surface 16 from ends of both terraces 20 facing both ends of the sealed surface 16 up to a location adjacent to an accommodation part 14 (main room), and the folding lines L are formed to have lengths corresponding to sealing areas of both terraces 20, and the folding lines L and the accommodation part 14 (main room) are formed to maintain an interval of 1 mm or more.

In addition, at the same time, the lower molds 120a and 120b, and the upper molds 130a and 130b transfer heat to the shark fins 18 and the terrace 20 to melt an adhesive layer, and the melted adhesive layer flows to a part where electrical insulation is broken while being pressed by the lower molds 120a and 120b, and the upper molds 130a and 130b.

Meanwhile, when the forming of the folding line L is completed, the Z-axis transfer means is actuated to return the upper molds 130a and 130b, and at the same time, the X-axis transfer means is actuated to return the lower molds 120a and 120b, and the upper molds 130a and 130b.

In the shark fin forming device 100 of the 3-sided sealing pouch type secondary battery 10 according to the present invention formed as such, the folding line which is the folding reference line may be easily formed to the shark fins 18 of the 3-sided sealing pouch type secondary battery 10, and as a result, the shark fin 18 may be easily folded in the subsequent process.

Further, in the shark fin forming device 100 of the 3-sided sealing pouch type secondary battery according to the present invention, since heat and pressure are assigned upon forming the folding line L, the melted adhesive layer may flow to a part where electrical insulation is broken due to the forming of the folding line L, and as a result, the electrical insulation for the adhesive layer may be ensured.

What is claimed is:

1. A device for forming a shark fin of a 3-sided sealing pouch type secondary battery, the device comprising:
lower molds on which lower surfaces of the shark fins formed outside front and rear ends of a sealed surface and an accommodation part of the 3-sided sealing pouch type secondary battery, and a lower surface of a terrace connected to the shark fins are seated; and
upper molds pressing the shark fins seated on the lower molds, and the terrace connected to the shark fins to form folding lines between the shark fins and the terrace,
wherein the folding lines are formed to be aligned with the sealed surface up to a location adjacent to the sealed surface and the accommodation part from both ends of the terrace facing the sealed surface, and
the folding lines are formed to have a length corresponding to a sealing area of the terrace, and the folding lines are formed to maintain an interval of 1 mm or more from the accommodation part.

2. The device for forming a shark fin of a 3-sided sealing pouch type secondary battery of claim 1, wherein forming processing surfaces on which lower surfaces of the shark fins formed outside the front and rear ends of the sealed surface and the accommodation part, and the lower surface of the terrace connected to the shark fins are seated are formed on upper surfaces of the lower molds.

3. The device for forming a shark fin of a 3-sided sealing pouch type secondary battery of claim 2, wherein a concave folding line forming groove is formed on the forming processing surface in a longitudinal direction of the sealed surface.

4. The device for forming a shark fin of a 3-sided sealing pouch type secondary battery of claim 2, wherein heating elements are installed inside the lower molds.

5. The device for forming a shark fin of a 3-sided sealing pouch type secondary battery of claim 2, wherein the lower molds are guided to a folding line forming location jointly with the upper molds by actuation of an X-axis transfer means to seat the lower surfaces of the shark fins, and a lower surface of the terrace connected to the shark fins on the forming processing surface, and are returned by the actuation of the X-axis transfer means jointly with the upper molds upon completing the forming of the folding line.

6. The device for forming a shark fin of a 3-sided sealing pouch type secondary battery of claim 3, wherein a convex folding line forming protrusion which is extended in the longitudinal direction of the sealed surface, and matched with the folding line forming groove to form the folding line is formed on lower surfaces of the upper molds.

7. The device for forming a shark fin of a 3-sided sealing pouch type secondary battery of claim 6, wherein a cross-sectional shape of one end or both ends of the folding line forming protrusion is formed to be gradually reduced to a side surface of the upper mold.

8. The device for forming a shark fin of a 3-sided sealing pouch type secondary battery of claim 6, wherein a pressing area pressing the shark fins and the both terraces flatly is formed on an outer side of extension ends of the folding line forming protrusion and the folding line forming groove forming the extension end of the folding line is formed at a location adjacent to the front and rear ends of the sealed surface and the accommodation part.

9. The device for forming a shark fin of a 3-sided sealing pouch type secondary battery of claim 6, wherein heating elements are installed inside the upper molds.

10. The device for forming a shark fin of a 3-sided sealing pouch type secondary battery of claim 2, wherein the upper molds are guided to a folding line forming location jointly with the lower molds by actuation of an X-axis transfer means, and moved down by actuation of a Z-axis transfer means, and press spaces between the shark fins seated on the forming processing surface and the terrace to bend and form the folding lines between the shark fins and the terrace, and moved up by the actuation of the Z-axis transfer means upon completing the forming of the folding line, and at the same time, returned by the actuation of the X-axis transfer means jointly with the lower molds.
